(19) United States
(12) Patent Application Publication
(10) Pub. No.: US 2024/0124326 A1
(43) Pub. Date: Apr. 18, 2024

(54) SYSTEM FOR IN-LINE ENRICHMENT OF LIQUIDS

(71) Applicant: STRAUSS WATER LTD, Or Yehuda (IL)

(72) Inventors: Georgy MAIKOV, Haifa (IL); Shlomo RECHES, Petah Tikva (IL); Eddy MAKMEL, Mazkeret Batya (IL)

(73) Assignee: STRAUSS WATER LTD, Or Yehuda (IL)

(21) Appl. No.: 18/277,327

(22) PCT Filed: Jan. 25, 2022
(86) PCT No.: PCT/IL2022/050100

§ 371 Date: Aug. 15, 2023

(30) Foreign Application Priority Data
Feb. 17, 2021 (IL) 280933
Oct. 28, 2021 (IL) 287663

(51) Int. Cl. C02F 1/00; B67D 1/00; B67D 1/07; B67D 1/08; B67D 1/12; C02F 1/68

(52) U.S. Cl. CPC C02F 1/008; B67D 1/0021; B67D 1/0031; B67D 1/0032; B67D 1/0079; B67D 1/07; B67D 1/0857; B67D 1/122; C02F 1/686; C02F 2209/40

(57) ABSTRACT

The present disclosure concerns systems for enriching liquids with one or more additives. More particularly, the disclosure concerns systems for in-line addition of various nutrients into drinking water, the system being configured to add an accurate amount of nutrient into the water as it flows in the supply line based on the actual volume of water flowing through the line.

### TECHNOLOGICAL FIELD

The present disclosure concerns systems for enriching liquids with one or more additives. More particularly, the disclosure concerns systems for in-line addition of various nutrients into liquids, e.g. drinking water.

### BACKGROUND ART

References considered to be relevant as background to the presently disclosed subject matter are listed below:
U.S. Pat. No. 9,725,297
U.S. Pat. No. 10,724,515
EP 0945171

Acknowledgement of the above references herein is not to be inferred as meaning that these are in any way relevant to the patentability of the presently disclosed subject matter.

### BACKGROUND

Water, typically drinking water, are an important source for various minerals and nutrients. Water often differs in composition depending on various factors, having an effect on the type of minerals and nutrients present in the water and their quantities. For example, water from different sources, e.g. rivers, lakes, wells, reverse osmosis, filtration, etc. typically contain different minerals and nutrients profile. Other factors effecting the composition of water originating from natural sources can be weather conditions, geographical location, environmental factors, and many others.

Insufficient consumption of nutrients and minerals has become a problem in recent years, as water treatment systems utilized to purify drinking water typically remove some, if not most, of the nutrients and minerals from the water dispensed for consumption. Thus, artificial addition of nutrients and minerals is often required in order to provide drinking water with desired and balanced nutritional values.

One approach for enriching water with various nutrients is to add nutrients into bulk quantities of water, e.g. into reservoirs or containers of treated water from which water is supplied for consumption. Such addition is typically made directly into the reservoir and is often carried out in discrete bulk additions (i.e. large discrete quantities are added directly into the reservoir). Another approach is to add a constant, pre-determined amount of nutritional additive into a constant, pre-determined volume of water (e.g. a defined dose per liter of water). Such approaches often result in inaccurate enrichment, causing overdosing or underdosing of nutrients.

Due to the large variability in source water quality, a system that provides accurate, in-line addition of various nutrients into water is required, that permits on-demand enrichment of water, depending on the actual content of nutrients already present in water and in real time immediately prior to consumption.

### GENERAL DESCRIPTION

The present disclosure provides systems, typically, albeit not exclusively, integrated into water dispensers, that enable accurate addition of various nutrients into water per demand. In other words, systems described herein dynamically and selectively enrich water with one or more nutrients, providing variability in the type and amount of nutrients added into the water during their dispensing, depending on the actual volume of water that is dispensed. Such systems enable the user to customize the nutrients' profile in the water depending on the quality of the source water and individual needs of the user, as well as higher accuracy of enrichment.

Thus, in one of its aspects, the present disclosure provides a system for continuous dosing of one or more nutrients into water, the system comprising a water flow line defined between a water inlet and a water outlet, at least one nutrient inlet formed in the water flow line and configured for association with one or more nutrient containers, at least one liquid flow indication arrangement configured for providing one or more indicators of water volume flowing in a flow line, and a control module. Each of the one or more containers holds a nutrient substance and is associated with a dosing pump, and configured to add the nutrient substance into the flow line through the one or more nutrient inlets defined in the flow line. The control module is configured to receive at least one indicator of water volume from the liquid flow indication arrangement, and induce the dosing pump to dispense one or more dosed quantities of nutrient substance from the container into the flow line as a function of said water volume during flow of the water through the flow line.

In other words, the control module receives real-time measurements of the volume (or an indicator indicating the volume) of water as it flows in the flow line, and according to the actual volume of water—calculates the required amount of nutrients to be added to the water, and induces the dosing pump associated with the nutrients' container(s) to continuously (i.e. incrementally) add the required dose of nutrient substances into the water during its flow through the flow line.

In such a manner, accurate and continuous addition of nutrients is enabled as the water flows in the flow line. For example, in case the system has received an input for dispensing one liter of water, however actually only part of the volume has been dispensed, the amount of nutrients added to the water will be according to the actual partial amount that is dispensed and not an amount suitable for enriching one liter of water. Thus, unlike other systems in which a constant amount of nutrients is added to the drinking glass based on an initial input of a water volume to be dispensed (such addition being made typically after the amount of water has been dispensed) regardless of whether such amount of water was actually dispensed, the systems of this disclosure permit highly controlled and continuous addition of nutrients during flow of the water that is dictated by the actual volume of water that is dispensed in order to allow a user to consume water with an accurate and controlled nutrients profile.

It is to be understood that the term dosing pump refers to any mechanical or electronical arrangement that permits dosed dispensing of the nutrient substance from the container, i.e. permitting dispensing of defined quanta or volumes of the nutrient. The dosing pump may be a peristaltic pump, a mechanical pump, a metered-dose unit, a syringe with a reciprocating piston, etc.

By some embodiments, the liquid flow indication arrangement is a flow regulator, configured to provide a pre-determined flow rate of water in the water flow line, and said indicator being the measured flow time of water through the flow line. In other words, by knowing the flow rate provided by the flow regulator, the controller can receive, in real time, the duration (e.g. number of seconds) of water flow, thus providing real time indication of the volume of water flowing in the flow line, and correlate the required doses of nutrients for addition to the water.

By other embodiments, the liquid flow indication arrangement is a flow meter, that can measure or indicate the volume of water flowing through the flow line in real time. The flow meter can, by some embodiments, be selected from an optical flow meter, a mechanical flow meter, a thermal flow meter, an RF flow meter, a differential pressure flow meter, weight flow meter, light flow meter, or any other suitable flow meter.

For example, the control module can be configured to receive a desired final content of nutrients in the water, and the number of steps (or rotations) a mechanical flow meter actually makes during the flow of water along the flow line. By knowing the number of strokes of the dosing pump and the volume of nutrient dispensed by each stroke, the control module can correlate the number of steps to the number of required strokes to obtain the desired doses of nutrient substance to be added to the water as it flows in the flow line, thus obtaining accurate addition of nutrients to the water. Such correlation can vary depending on the water flow rate, the type of nutrient, the amount of nutrient in the source water, the concentration of nutrient in the nutrient substance, etc.

While this disclosure refers mainly to water, it is to be understood that other aqueous liquids can also be supplemented with one or more nutrients utilizing the systems of this disclosure. Such aqueous liquids may be, for example, various beverages such as milk, juice, coffee drinks, soft drinks, sparkling water, etc.

The term nutrient substance is meant to denote a compound or composition of compounds that provides one or more nutritional values to the user. The substance may comprise a single type of nutrient in various forms (for example a mineral in form of different salts) or may comprise a blend of one or more types of nutrients. The nutrient substance may be provided in a diluted form or may be in the form of a concentrate. The nutrients can be present in the nutrient substance in an encapsulated form. Such encapsulation is particularly desired for delivery of hydrophobic nutrients. In addition, such encapsulation may reduce the conductivity of water, as encapsulated minerals typically do not increase the conductivity of water. Thus, such encapsulation enables to maintain a constant conductivity of the water (i.e. the same conductivity before and after mineral addition), in spite of the favorable addition of minerals.

The nutrient substance, by some embodiments, is selected from minerals, vitamins, amino acids, fatty acids, proteins, flavoring agents, odorants, food supplements, peptides, antioxidants, nutraceuticals, probiotics, emulsifiers, thickening agents, antifoaming, colorants, flavor masking agents (e.g. gum arabic), preservatives, stabilizers, stimulants (such as caffeine, tea extract or concentrate, coffee extract or concentrate, chocolate), nutritional fibers, fatty acids, nutritional proteins, prebiotics, probiotics, alcoholic compounds, juice, juice concentrate, and any combination thereof.

In some embodiments, the nutrient is at least one mineral. The mineral is typically an essential mineral, and may be selected from calcium, magnesium, zinc, selenium, phosphorus, potassium, sulfur, sodium, iron, copper, manganese, iodine, molybdenum, chromium, fluoride, inorganic salts thereof (such as chloride, carbonate or bicarbonate salts) and/or organic salts thereof.

In other embodiments, the nutrient is at least one vitamin. The vitamin can be typically selected from vitamin A, vitamin B (e.g. one or more of vitamin B1 (thiamine), B2 (riboflavin), B3 (niacin), B5 (pantothenic acid), B6 (pyridoxine), B7 (biotin), B9 (folate) and B12 (cobalamin)), vitamin C, vitamin D, vitamin E, etc., in a single vitamin formulation or as a vitamin complex or multivitamin formulation. The at least one vitamin may be added to the water in a desired quantity, e.g. at a quantity of about 1-35% of the recommended daily amount.

The nutrient substance can be in any suitable form, e.g. liquid, gel, emulsion, microemulsion, solution, dispersion, suspension, powder, etc.

When in powder form (or a viscous liquid form), the nutrient substance can be dispersed or dissolved in a carrier liquid (e.g. water) before adding it to the water flow through the flow line. Such dispersion or dissolution can be obtained, by some embodiments, by utilizing an auxiliary pump to introduce a desired amount of carrier liquid into the container. In other embodiments, the dosing pump can be a dual pump, permitting, in a selective manner, to introduce the carrier liquid into the container for suspending or dissolving the nutrient substance, and then dispense the suspended or diluted nutrient substance into the water flow line. The control module can induce such a dual dosing pump to first dilute the nutrient substance and then introduce the diluted nutrient into the water flow line, taking into account the volume of water required for such dilution.

At least one of the containers can, by some embodiments, comprise a mixing arrangement (e.g. mechanical mixer, static mixer, magnetic mixer, etc.) to permit mixing of their content when desired (for example when the nutrient substance is a non-homogenous composition and/or when dilution or suspension of the nutrient substance in a carrier liquid needs to be carried out before dispensing it into the water flow line). In some embodiments, each of the containers comprises such a mixing arrangement. The system is configured for association with the mixing arrangement, to enable mixing of the content of the container once the container is associated with the nutrient inlet.

The container may be flexible, rigid, pliable, or collapsible; may have various shapes, sizes and volumes. In some embodiments, the system comprises a plurality of (two or more) containers, each independently holding a different nutrient substance. The containers may be re-fillable (i.e. a fixed container which can be filled by the user). In other embodiments, the containers may be replaceable and/or dispensable. The containers can be provided separately or as a cartridge, e.g. a replaceable cartridge, that holds several containers.

By some embodiments, the system is further configured to receive at least one cleaner container, containing one or more cleaning substances (e.g. cleaning substance that is non-toxic or non-harmful to the user), for cleaning the water flow line in between cycles of operation or before/after replacement of the nutrient containers.

According to some embodiments, all of the containers are associated with the same dosing pump, and hence with a single, common nutrient inlet. In such embodiments, the dosing pump may have a variably controlled stroke, such that the control module can change the stroke of the dosing pump depending on the nutrient that is to be selectively dispensed by the common dosing pump into the water flow line.

By other embodiments, each of the one or more containers is associated with a separate dosing pump, such that each of the one or more containers is independently in liquid communication with a nutrient inlet. In such cases, risk of intermixing of different substances outside of the flow line or contamination of the dosing pumps can be avoided. The dosing pump(s) can be integral with the nutrient inlet(s), and the containers (or cartridge) are associable with the dosing pumps. In other embodiments, the dosing pump(s) is(are) integral with the container(s), such that the dosing pump is configured for association with the nutrient inlet(s). Hence, when the container is replaceable and the dosing pump is integral therewith, the container and its dosing pump can be removed together from the system for replacement.

In embodiments in which the containers are held within a cartridge, the cartridge has a cartridge outlet, that is configured for establishing liquid communication with a nutrient inlet of the flow line, such that the nutrients can be dispensed from the cartridge out of a single cartridge outlet. In other embodiments, the cartridge has a plurality of cartridge outlets, each being configured for liquid communication with one container and one nutrient inlet.

By other embodiments, each of the one or more containers is held within a separate cartridge. In such cases, each separate cartridge has at least one cartridge outlet, being in liquid communication with a nutrient inlet of the flow line.

According to some embodiments, the cartridge is user-replaceable.

The containers can be configured for association with the nutrient inlet by any suitable means, such as screw-threading, bayonet arrangement, snap fitting, pressure fitting, etc.

It is to be appreciated that any of the containers and/or cartridges can include one or more identifiers (e.g. barcodes, RFID tags, QR codes, etc.) that carry various data about the containers and/or substances held therein. For example, such identifiers can include place and date of production, composition, expiry date, authentication data, etc. Thus, the system can include one or more readers configured to read the data provided by the identifiers and communicate such data to the control module. The control module, in turn, can authenticate the containers/cartridge and can shut the system off in case unauthorized containers/cartridge have been inserted into the system. The control module can also prevent operation of the system in case the containers/cartridge are close or at their expiration date, indicating to the user that such need to be replaced.

In order to maintain serviceability time of the containers/cartridge, the system can be configured to hold the containers/cartridge at a controlled temperature and/or humidity environment. For example, the system can be configured to hold the containers/cartridge at refrigerated conditions. The control module can be configured to modify the conditions in which the containers/cartridge are held, depending on the type of nutrient sub stance(s). For example, when a container or a cartridge is introduced into the system, an identifier code can be sent to the control module identifying the type of nutrient substance, and the control module can modify the storage conditions (e.g. temperatures) based thereon.

Refrigerated conditions can be obtained by any suitable means. By some embodiments, the cartridge holding the one or more containers is configured to be cooled by a cooling fluid, i.e. said cartridge is linked to a cooling fluid circulating sub-system (i.e. a closed-loop sub-system) configured to cool and circulate the cooling fluid within the cartridge. By some embodiments, the cooling fluid is cooled water.

By some embodiments, the cooling fluid circulating sub-system comprises a cooling fluid reservoir that is in fluid communication with a cooling arrangement, configured to cool the cooling fluid. In such embodiments, the reservoir is in closed-loop fluid communication with said cartridge, to permit cooling of the cartridge by circulating the cooling fluid. In such an arrangement, the cooling of the cartridge is not dependent on water outlet temperature, as the cooling arrangement functions to maintain the circulating fluid under a defined temperature range.

By some other embodiments, the cartridge is cooled by a cooling arrangement associated with the cartridge.

According to some embodiments, the system may comprise two or more liquid flow indication arrangement (e.g. flow meters or a combination of a flow meter and a flow regulator), spaced apparat from one another along the flow line. In cases where more than one such arrangement are used, the control module is configured to receive flow indication from each of the arrangements.

In order to determine one or more parameters of the water, before, after or during addition of the nutrient substance, the system, by some embodiments, comprises at least one sensor for measuring at least one parameter of the water in the flow line. For example, the system can comprise one or more sensors that measure or provide indication on the content of the nutrient in the source water, such that the actual measured initial content of nutrient is taken into account when the control module determines the dose of nutrient that needs to be added to the water, in order to arrive at a total amount of nutrient in the water that is optimal for user consumption.

According to some embodiments, the at least one sensor can be selected from a salinity sensor, a conductivity sensor, a total dissolved solids (TDS) sensor, a turbidity sensor, a pH sensor, temperature sensor, color sensor, a spectroscopic sensor, a magnetic sensor, a laser sensor, a viscosity sensor, radiofrequency sensor and any other suitable sensor to assess said parameter, etc.

By some embodiments, the system can comprise at least one first sensor positioned in the flow line upstream to the nutrient inlet(s) and at least one second sensor positioned in the flow line downstream to the nutrient inlet(s), such that the relevant parameter(s) can be measured before addition of nutrient substance(s) and thereafter, thus also providing quality control over the nutrients' addition process. The first and second sensors may be the same or different, and can measure same or different parameters.

In some embodiments, the control module is configured to selectively add a required dose of nutrient substances from the containers based on the measured parameters of the source water, and/or based on information of the nutrients' profile in the source water received from an external data source. In other words, the control module can selectively induce one or more of the dosing pumps to add different types and/or amounts of nutrient substances from the containers based on the actual content of the nutrients found or measured in the source water and the volume of source water then flows in the flow line. Thus, in some embodiments, the control module is configured to add one or more doses of one or more nutrient substances into the water, depending on the content of nutrient(s) in the water prior to said addition.

As noted, the control module, by some embodiments, can be configured to receive one or more parameters of the source water from an external data source, such data being taken into account when determining the addition of nutrient substance(s) into the water. The control module can communicate with said external data source in a wired manner or wirelessly.

For example, said one or more parameters of the source water can be selected from type of water source (well, river, lake, reservoir, desalination facility, reverse osmosis system, etc.), geographical location of the water source, content of nutrients in said the source water, environmental conditions at the water source, etc.

According to other embodiments, the control module can be configured to receive personalizes profiles of consumed water based on user's preference and/or user's profile. For example, the daily recommended amount of nutrients varies depending on age, weight, gender, medical condition, geographical location, lifestyle, etc. Thus, the control module can be programmed to store various users' profiles and provide the exact amount of nutrients needed for each user, for example by dispensing different amounts and/or different combinations of nutrient substances into the water. Alternatively, the control module can receive the user's profile from an external database. In another embodiment, the system can be configured with an array of sensors to identify the gender of a user and assess his/her age and/or weight.

In some embodiments, the total amount of nutrient substance(s) is based on a user's profile; the control module being configured to induce addition of nutrient substances to the water based on said user's profile to arrive at a desired final content of the nutrient specific for each user (or consumer).

In another embodiment, the system can be personalized to add nutrients to the water depending on the organoleptic preference of the consumer. For example, it is known that different content of some nutrients (e.g. minerals such as calcium and magnesium) causes water to be sensed differently by the tongue. Water that is low in mineral content will be often sensed as “rough” (what is known as “tough” water), while water that is low in mineral content will be sensed as “smooth” or “soft” water. According to consumer preference, one or more nutrients can be added to the water, depending on the initial measured value of the nutrient in the water, in order to obtain a desired or preferred organoleptic property of the water.

The systems of this disclosure can be formed as stand-alone systems, integrated into municipal or main water supply line, or integrated into water dispensers.

Hence, by another aspect, the present disclosure provides a water dispenser comprising a dispenser inlet for receiving source water from a water source, and a dispensing outlet, and a system for dosing one or more nutrient substances into water as described herein. The system is disposed between the dispenser inlet and the dispensing outlet, with the water inlet and the water outlet of the system being in liquid communication with the dispenser inlet and the dispensing outlet, respectively.

According to some embodiments, the water dispenser can further comprise at least one water treatment module, disposed between the dispenser inlet and said system, for removing one or more contaminants from the source water prior to addition of said one or more nutrient substances.

The water treatment module(s) are designed to carry out preliminary treatment onto the source water in order to remove various contaminants, e.g. microbiological contaminants, small particles or fibers, heavy metals, chlorine, organic materials, trihalomethanes (THMs), pesticides, hormones, drugs, etc., which are undesired for user's consumption. The water treatment module(s) can be configured to remove contaminants, however, substantially maintain the original minerals content in the source water, which are beneficial for user's consumption. This enables not only maintaining the desired nutrients in the water and removing undesired contaminants therefrom, but also enables utilizing a measured amount of the minerals in the water as an indication of the water quality. Hence, the added amount of nutrient substance(s) calculated by the controller can, in some embodiments, take into account the content of the nutrients in the water after being treated by said one or more water treatment modules.

By some embodiments, the water dispenser comprises one or more user-interface modules configured to receive user-input or user-preferences. The user-interface module is typically associated with the control module, and permits operating the system and/or displaying one or more notifications to the user. For example, the user interface can display the type and/or amount of nutrients added, one or more measured parameter, one or more informatory notifications, one or more nutritional recommendations, etc. Accordingly, the control module is typically configured to receive data from said user-interface module(s) and induce operation of the system based thereonto.

According to some embodiments, the user-interface module can be configured to display at least the TDS value of the water before, during and after addition of the nutrient substance(s). For example, the TDS value after treating water by reverse osmosis is typically low to zero (and can attest to the effectiveness of the reverse osmosis treatment). The user-interface can thus present the user with the initial TDS value before addition of the nutrient substance(s), during addition of the nutrient substance(s), and the final value after addition has been completed (in which the TDS value should be higher than the initial TDS value)—such that the increase in TDS value to a desired given value can serve as an indicator to the user of the proper and controlled addition of the nutrient substance(s) to the water.

The water dispenser can also comprise a user identification module, for identifying the user prior to operation of the system. For example, the identification module can be a fingerprint unit, a voice recognition unit, a camera-based utility for identifying facial features, etc., and the system can be induced to operation based on the user profile allocated to each identified user. In addition, such an identification module can be used as a safety means for preventing utilization of improper user profile. For example, the identification module can identify whether a child or an adult has operated the system, thereby preventing application of an adult-based profile when a child operates the system.

By some embodiments, the total amount of the added nutrient substance can be limited by the control module according to a safety profile, thus preventing unintentional consumption of a harmful dose of the nutrient. For example, by identifying the nutrient substance (e.g. from a barcode carried by the container), the control module can limit the amount of nutrient substance dispensed by the dosing pump per dispensed volume of water, either by accessing an internal database or contacting an external database providing the safety level thresholds for such nutrient substances.

The water dispenser may comprise additional systems, units, or modules, such as water-cooling system, water heating system, units for flavor additives, etc. In some embodiments, the dispenser comprises a water carbonation unit for carbonating the water prior to dispensing. The carbonation unit is typically positioned downstream the nutrient substances dosing system, as to prevent carbonation from effecting the values of parameters measured that form a basis of the control module's operation.

Another aspect of the present disclosure provides a method for continuous addition of one or more nutrients into water, the method comprises:
measuring a volume of source water flowing in a water flow line defined between a water inlet and a water outlet;
receiving, by a control module, an indicator indicating said volume of water and one or more parameters indicative of the content of said one or more nutrients in the source water, and determining, based on said indicator and parameters, a dose of one or more nutrient substances to be added to the source water; and
adding, during flow of the water through the flow line, said dose of one or more nutrient substances into the water from one or more nutrient substance containers being in liquid communication with the flow line during water flow in the flow line.

By some embodiments, the dose is further determined based on a desired content of said one or more nutrients in the water (prior to said addition). By other embodiments, the method includes measuring one or more parameters of the source water, to determine the content of nutrients in the source water before said adding. For example, a pre-determined threshold of desired nutrient content may be stored in the control module, and based on the measured water parameters and the water volume, the control module can induce the dosing pump to dose a quantity of one or more nutrient substances to obtain such pre-determined threshold. By another example, in case the content of a nutrient in the water exceeds a pre-determined threshold, the control module will not induce addition of nutrient substance into the water.

The method, by some embodiments, can comprise measuring one or more parameters of the water after said adding to determine the content of nutrients in water.

In order to maintain the flow line clean of nutrient substances remains, the method may include addition of the nutrient substances at discrete time or volume intervals during flow of water in the flow line. Thus, the method can comprise:
receiving user input of a quantity of water to be dispensed;
flowing a first volume of source water through said flow line;
flowing a second volume of source water flowing in the flow line, and adding said dose of one or more nutrients into said second volume of water during flow through the flow line, said dose being determined by said quantity of water and said one or more parameters indicative of the content of said one or more nutrients in the source water; and
flowing a third volume of source water through said flow line;
such that the sum of said first, second and third volumes of water is said quantity of water.

In other words, when demand to dispense a quantity of water is received, e.g. from user-input, a first volume of water is permitted to flow in the line without addition of nutrient substances. Nutrient substances are then added to the subsequent second volume of water, and the final, third volume of water is then permitted to flow without addition of the nutrient substances. In such a manner, the entire desired quantity of water is dispensed, however with the third volume of water functioning to flush the flow line to prevent residual nutrient substances from accumulating in the flow line. It is to be understood that in such methods, the amount of nutrient substance added into the second volume of water is calculated on the basis of the entire quantity of water to be dispensed.

By another example, typically in system in which water can be provided at different temperatures, lukewarm water is dispensed by intermittently dispensing hot and cold water. As some nutrients are unstable at elevated temperatures and cannot be added to hot water, enrichment of lukewarm water can be carried out during dispensing of cold water portion from a cold water flow line, such that the total amount of nutrient added is calculated on the basis of the entire volume of lukewarm water to be dispensed.

In another example, nutrient substance is added to a non-predetermined amount of source water—namely, the user does not input a desired given amount of water, but continuously dispenses water on demand (e.g. as long as a dispensing actuation button is held pressed by the user, source water is being fed to the system). In such cases, the method can comprise flowing a first volume of source water through said flow line upon receipt of demand for water from a user; and continuously flowing source water in the flow line as per user demand, and adding said dose of one or more nutrient substances into said water during the continuous flowing through the flow line, the control module determining the amount of nutrient substance to be added based on said first volume of source water and the volume during the continuous flow, such that said dose being incrementally added during the continuous flow of water, based on said first volume and the volume of water flowing during the continuous flow.

In other words, a first volume of water is dispensed upon user demand in order to flush the flow line without nutrient substance being added thereto. After dispensing of the first volume, water is being dispensed continuously, as long as there is demand for such dispensing from the user. As the controller induces the dosing pump to add incremental doses of nutrient substance into the water depending on their rate of flow through the flow line, the control module can take into account the first volume of water when calculating the total dose of nutrients. Hence, the control module can induce the dosing pump to add slightly larger doses of nutrient substance into the water (compared to such addition when nutrient substance is added from the start of water dispensing), as to compensate for the lack of addition to said first volume. In some embodiments, the dose is determined based on said first volume, the volume of water flowing during the continuous flow, and said one or more parameters indicative of the content of said one or more nutrients in the source water.

The method can also comprise presenting a user with a final value indicative of the total amount of nutrients in the quantity of water after the addition. In embodiments were then nutrient is added continuously only to a portion of the volume of water, the final value can be determined by the dose of nutrient added to said portion of volume multiplied by one or more calibration factors.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 shows a schematic representation of a system according to an embodiment of the present disclosure;

FIG. 2 shows a schematic representation of a system according to another embodiment of the present disclosure;

FIG. 3 shows a schematic representation of a system according to yet another embodiment of the present disclosure;

FIG. 4 shows a schematic representation of a water dispenser comprising a system according to an embodiment of the present disclosure.

FIG. 5 shows a perspective view of a system according to an embodiment of this disclosure.

### DETAILED DESCRIPTION OF EMBODIMENTS

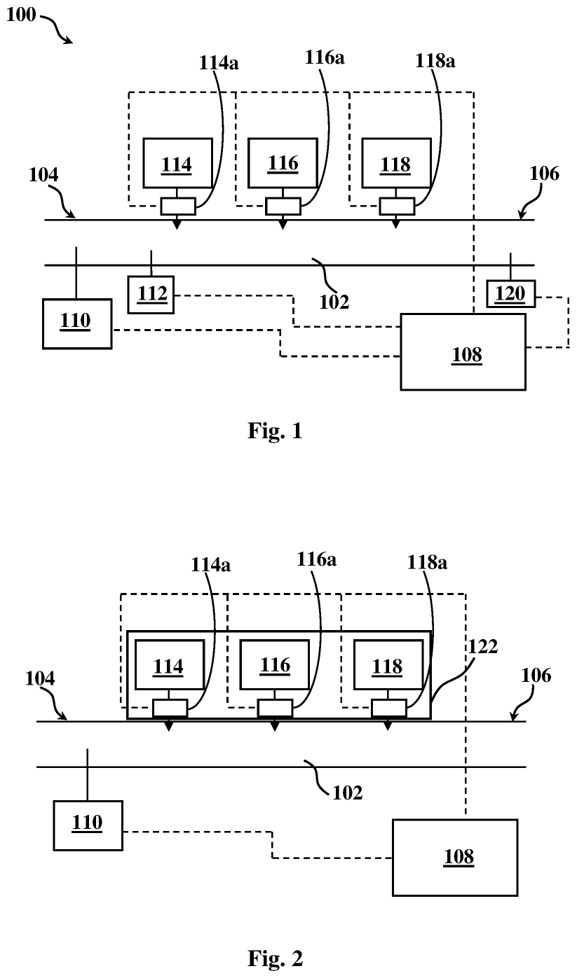

Turning to FIG. 1, shown is an exemplary dosing system according to an embodiment of this disclosure. In the examples herein, solid lines represent physical connection between elements, while dashed line indicate data transfer or communication. It is to be understood that communication lines may be physical (i.e. wired) or be wireless.

System 100 comprises a water flow line 102, extending between water inlet 104 and water outlet 106. With water flowing in a direction from the inlet to the outlet. A control module 108 is linked to flow meter (or flow regulator) 110, that provides continuous indication of the volume of water passing through the flow line and provides the control module 108 with water flow data in real time.

The control module 108 can receive data indicating the content of nutrients in the source water from an external source. Alternatively, sensor 112 can be located near the water inlet 104, and is configured to measure and provide a first value of at least one measurable parameter of the water, such as conductivity, turbidity, pH and any other parameter that may be correlative to the amount of the nutrient in the source water.

The first value measured by sensor 112 is typically transmitted to the control module 108, and together with the data received from the flow meter 110 and the desired content of nutrient(s) in the water suitable for consumption, calculates the required amount of nutrient substance(s) to be added from one or more of nutrient substances containers 114, 116 and 118. While three such containers are shown in the example, it is to be understood that the system can include only one such container, two containers, three containers, or more than three containers.

Each of the containers is associated or integrated with a dosing pump 114a, 116a and 118a, respectively, each of which being in communication with control module 108. Hence, according to the nutrient content in the source water and the volume of water flowing in the flow line, the control can operate each of the dosing pumps independently in order to dispense the required amounts of nutrient substance(s) into the water. For example, depending on the desired final nutrients profile, the control module 108 can induce only one of the dosing pumps 114a, 116a, 118a to operation, or more than one of the dosing pumps into operation. Different quantities or ratios of nutrient substances can be dispensed, depending on the desired final nutrients profile, the volume of water for dispensing and the initial nutrients profile in the water.

Sensor 120, located downstream to the containers, can measure a parameter indicative to the nutrients' content, thereby providing the control module with an indication about the amount of nutrients in the water after addition.

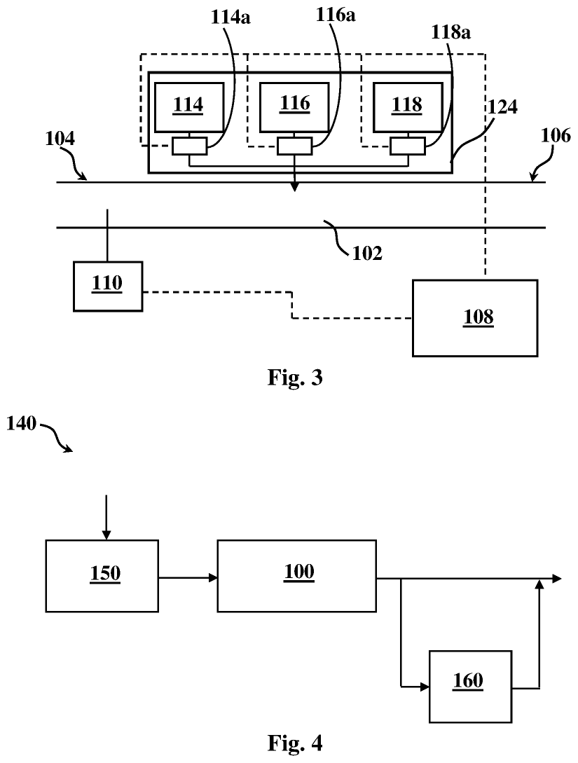

FIG. 2 exemplifies a similar system to that of FIG. 1, however, in this example the containers 114, 116 and 118 are held within a cartridge 122. Cartridge 122 can be user-replaceable, permitting the user to replenish the containers or remove the cartridge when the nutrient substances are close to their expiration date. Cartridge 122 is configured to link each of the containers 114, 116, 118 held therein with a designated nutrient inlet along the flow line.

Similar arrangement is shown in FIG. 3, however in this example, cartridge 124 that holds containers 114, 116, 118 is linked to flow line 102 through a single, common nutrient inlet. While FIG. 3 demonstrates that the containers are held in a cartridge, it is to be appreciated that the containers can be linked to the single, common nutrient inlet without being held in a cartridge (for example, each of the containers can be separately linked to a manifold, the manifold being associated with the common nutrient inlet).

It is also to be appreciated that each or all of the containers and cartridges can bear unique identification and/or authentication labels/barcodes, permitting verification that proper containers or cartridges have been introduced into the system. Further, such labels or barcodes can also carry data indicative of the expiration date of the nutrient substances contained therein, and the control module is configured to shut-off operation of the system in case unauthorized or expired containers or cartridges have been inserted into the system.

Exemplified in FIG. 4 is a schematic representation of a water dispenser utilizing the system of the disclosure. Water fed into dispenser 140 from a water source (not shown), typically into water treatment module 150, in which it can be treated to remove undesired contaminants, for example to remove microbiological contaminants, heavy metals, organic materials, etc. It is of note, however, that module(s) 150 is designed such that no substantive removal of desired nutrients (e.g. minerals) takes place, hence maintaining substantively the content of desired nutrients of the source water. While removal of undesired contaminants is preferable as it may assist in more accurate determination of the nutrient content in the water, it is not mandatory. Hence module(s) 150 can also be absent from the system. Water is then fed into system 100, and after obtaining the desired nutrients profile, enriched water can be dispensed from the dispenser through a dispensing outlet (not shown). In case carbonated water is desired, water can be diverted into carbonation system 160 after enrichment before dispensing to the consumer.

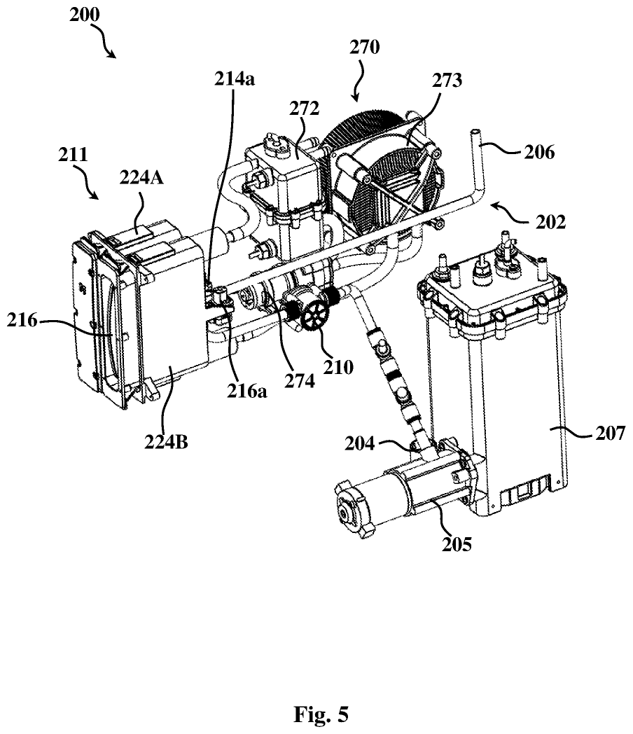

FIG. 5 shows an embodiment of a system according to this disclosure. System 200 comprises a water flow line 202, extending between water inlet 204 and water outlet 206. In this example, water inlet 204 is fed treated water from treatment module 207 by the driving force of pump 205. Flow meter (or flow regulator) 210 is located downstream water inlet 204 and provides continuous indication of the volume of water passing through the flow line, thereby providing the control module (not shown) with water flow data in real time.

Nutrient substances are added into the flow line from assembly, generally designated 211, that, in this particular embodiment, includes cartridges 224A and 224B. Cartridge 224B is shown with its front door removed, to enable view of substance container 216 contained therein (e.g. in the form of collapsible bag). In this specific example, each container (and hence also each cartridge) is associated or integrated with a dosing pump 214a and 216a, each of which being in communication with the control module to enable continuous addition of nutrient substances into the water flowing in flow line 202 based on the volume of water flowing in real time through the flow line as indicated or measured by flow meter 210 according to the methods described hereinabove.

In this specific example, the cartridges 224A and 224B are associated with a cooling fluid circulating sub-system, generally designated 270. Sub-system 270 includes, in this example, a cooling module that includes a cooling reservoir 272 and a cooling arrangement 273 configured to cool the cooling fluid, e.g. water, and circulate it using circulation pump 274 through the cartridge assembly 211, thereby maintaining the containers held within cartridges 224A and 224B under constant temperature conditions.

1. A system for continuous dosing of one or more nutrients into water, the system comprising:
a water flow line, defined between a water inlet and a water outlet;
at least one nutrient inlet formed in the water flow line and configured for association with one or more containers, each container holding a nutrient substance and associated with a dosing pump, and configured to add the nutrient substance into the flow line at one or more nutrient inlets defined in the flow line;
at least one liquid flow indication arrangement configured for providing one or more indicators of water volume flowing in a flow line; and
a control module configured to receive at least one indicator of the water volume from the liquid flow indication arrangement, and induce the dosing pump to dispense one or more dosed quantities of nutrient substance from the container into the flow line as a function of said water volume during flow of the water through the flow line.

2. The system of claim 1, wherein each of the one or more containers is associated with a dosing pump.

3. The system of claim 2, wherein the dosing pump is integral with the container.

4. (canceled)

5. The system of claim 1, wherein each of said one or more containers is independently in liquid communication with a nutrient inlet.

6. The system of claim 1, wherein the flow line comprises a single nutrient inlet for introducing nutrient substance from one or more of the containers into the flow line.

7. The system of claim 1, wherein said at least one or more containers are held within a cartridge.

8. The system of claim 7, wherein said cartridge has at least one cartridge outlet, being in liquid communication with a nutrient inlet of the flow line.

9. (canceled)

10. The system of claim 7, wherein all of the containers in the cartridge are associated with a single, common dosing pump.

11. The system of claim 10, wherein the common dosing pump has a variably controlled stroke, variable by the control module.

12. The system of claim 1, wherein each of the one or more containers is held within a separate cartridge.

13. The system of claim 12, wherein each separate cartridge has at least one cartridge outlet, being in liquid communication with a nutrient inlet of the flow line.

14. (canceled)

15. The system of claim 5, wherein said cartridge is configured to be cooled by a cooling fluid.

16. (canceled)

17. (canceled)

18. (canceled)

19. The system of claim 1, wherein the system comprises at least one sensor for measuring at least one parameter of the water in the flow line, the at least one sensor is selected from the group consisting of a salinity sensor, a conductivity sensor, a total dissolved solids (TDS) sensor, a turbidity sensor, a pH sensor, and temperature sensor.

20. (canceled)

21. The system of claim 19, comprising at least one first sensor positioned in the flow line upstream to the nutrient inlet(s) and at least one second sensor positioned in the flow line downstream to the nutrient inlet(s).

22. (canceled)

23. The system of claim 1, wherein said liquid flow indication arrangement is a flow regulator, configured to provide a pre-determined flow rate of water in the water flow line, said indicator being the measured flow time of water through the flow line.

24. The system of claim 1, wherein said liquid flow indication arrangement is a flow meter.

25. (canceled)

26. The system of claim 1, wherein the control module is configured to add one or more doses of one or more nutrients into the water, depending on the content of nutrient(s) in the water prior to said addition.

27. (canceled)

28. The system of claim 1, wherein the control module is configured to receive one or more parameters of the source water from an external data source.

29. (canceled)

30. (canceled)

31. A water dispenser comprising:
a dispenser inlet for receiving source water from a water source, and a dispensing outlet, and
a system according to claim 1, disposed between the dispenser inlet and the dispensing outlet, the water inlet and the water outlet of the system being in liquid communication with the dispenser inlet and the dispensing outlet, respectively.

32. The water dispenser of claim 31, comprising (i) at least one water treatment module, disposed between the dispenser inlet and said system, for removing one or more contaminants from the source water, and/or (ii) one or more user-interface modules configured to receive user-input or user-preferences, the control module is configured to receive data from said user-interface module(s) and induce operation of the system based thereonto.

33. (canceled)

34. (canceled)

35. A method for continuous addition of one or more nutrients into water, the method comprising:
measuring a volume of source water flowing in a water flow line defined between a water inlet and a water outlet;
receiving, by a control module, at least one indicator indicating said volume of water and one or more parameters indicative of the content of said one or more nutrients in the source water, and determining, based on said indicator and parameters, a dose of one or more nutrient substances to be added to the source water; and
adding, during flow of the water through the flow line, said dose of one or more nutrient substances into the water from one or more nutrient substance containers being in liquid communication with the flow line.

36. (canceled)

37. The method of claim 35, comprising measuring (i) one or more parameters of the source water, to determine the content of nutrients in the source water before said adding, and/or (ii) one or more parameters of the water after said adding to determine the content of nutrients in water.

38. (canceled)

39. The method of claim 35, comprising:
receiving user input of a quantity of water to be dispensed;
flowing a first volume of source water through said flow line;
flowing a second volume of source water in the flow line, and adding said dose of one or more nutrients into said second volume of water during flow through the flow line, said dose being determined by said quantity of water and said one or more parameters indicative of the content of said one or more nutrients in the source water; and
flowing a third volume of source water through said flow line;
such that the sum of said first, second and third volumes of water is said quantity of water.

40. (canceled)

41. The method of claim 35, comprising:
flowing a first volume of source water through said flow line upon receipt of demand for water from a user; and
continuously flowing source water in the flow line as per user demand, and adding said dose of one or more nutrient substances into said water during the continuous flowing through the flow line, the control module determining the amount of nutrient substance to be added based on said first volume of source water and the volume during the continuous flow, such that;
said dose being incrementally added during the continuous flow of water, based on said first volume and the volume of water flowing during the continuous flow,
wherein said dose being determined based on said first volume, the volume of water flowing during the continuous flow, and said one or more parameters indicative of the content of said one or more nutrients in the source water.

42. (canceled)
